(19) United States
(12) Patent Application Publication
(10) Pub. No.: US 2024/0259979 A1
(43) Pub. Date: Aug. 1, 2024

(54) TECHNIQUE FOR NETWORK SLICE REJECTION AND ADMISSION CONTROL IN A TELECOMMUNICATION SYSTEM

(71) Applicant: Telefonaktiebolaget LM Ericsson (publ), Stockholm (SE)

(72) Inventors: Emiliano Merino Vazquez, Madrid (ES); Miguel Angel Garcia Martin, Madrid (ES); Xinyu Zhang, Shanghai (CN); George Foti, Dollard des Ormeaux (CA)

(21) Appl. No.: 18/290,048

(22) PCT Filed: May 25, 2022
(86) PCT No.: PCT/EP2022/064187

§ 371 Date: Nov. 9, 2023

(30) Foreign Application Priority Data
May 26, 2021 (WO) PCT/CN2021/096081

(51) Int. Cl. H04W 60/04; H04W 48/18

(52) U.S. Cl. CPC H04W 60/04; H04W 48/18

(57) ABSTRACT

A technique for handling rejection and admission of a terminal device to a core network, CN, of a telecommunication system is provided. As to a method aspect, a method comprises a step of receiving a terminal device registration request indicative of the terminal device requesting access to the telecommunication system. The method further comprises the step of sending, to a network slice selection function, NSSF, of the CN, a CN registration request message indicative of the terminal device registration request. The CN registration request message comprises an identifier of the terminal device. The CN registration request message is further indicative of at least one network slice of the telecommunication system. The method further comprises the step of receiving, from the NSSF, a CN response message indicative of rejection or admission to at least one network slice regarding the terminal device based on the identifier of the terminal device.

### TECHNICAL FIELD

The present disclosure relates to a technique for network slice rejection and admission control in a telecommunication system. More specifically, and without limitation, methods and devices for handling, determining, and controlling the rejection and admission of a terminal device to a core network of a telecommunication system are provided.

### BACKGROUND

The Third Generation Partnership Project (3GPP) defined in the 3GPP document TS 23.502, version 17.0.0, “Procedures for the 5G System (5GS)” a network slice admission control service (NSAC), which allows to limit the number of radio devices, also referred to as user equipments (UEs), or the number of users registered in a given network slice of a telecommunication system as defined by operator policies.

Sec. 4.2.11.2 of the 3GPP document TS 23.502, version 17.0.0, describes an availability check and update procedure regarding the number of UEs per network slice in order to update (i.e., increase or decrease) the number of UEs registered with a single network slice selection assistance information (S-NSSAI) which is subject to NSAC. An access and mobility function (AMF) is configured with the information indicating which network slice is subject to NSAC. The AMF triggers the number of UEs per network slice availability check and update procedure to update the number of UEs registered with a network slice of the telecommunication system when a network slice subject to NSAC is included or removed from the allowed S-NSSAI or S-NSSAIs for a UE. The procedure is triggered at UE registration procedure, as per clause 4.2.2.2.2 of the 3GPP document TS 23.502 V17.0.0 either before a Registration Accept in step 21 if an early admission control (EAC) mode is active or after the Registration Accept message if the EAC mode is not active. A network function (NF) NSAC function (NSACF), as defined in the 3GPP document TS 23.502, version 17.0.0, can be deployed as standalone NF or co-located within legacy NFs.

Conventionally, if UEs are trying to register and the limit of registered UEs has been reached in the requested network slice(s) of the telecommunication system, there is a waste of resources which are dedicated to authenticating and checking roaming agreements which involve a plethora of exchange messages relating to the AMF, Authentication Server Function (AUSF), Access Rule File (ARF), Unified Data Management (UDM), unified data repository (UDR) and to UE interactions.

### SUMMARY

Accordingly, there is a need for a technique that saves resources when performing network slice rejection and admission control in a telecommunication system. Alternatively or in addition, there is a need for a technique that reduces signaling overhead, in particular in case one or more network slices are not accessible.

As to a first method aspect, a method of handling rejection and admission of a terminal device to a core network (CN) of a telecommunication system is provided. The method comprises or initiates a step of receiving a terminal device registration request indicative of the terminal device requesting access to the telecommunication system. The method further comprises or initiates a step of sending, to a network slice selection function (NSSF) of the CN, a CN registration request message indicative of the terminal device registration request. The CN registration request message comprises an identifier of the terminal device. The CN registration request message is further indicative of at least one network slice of the telecommunication system. The method further comprises or initiates a step of receiving, from the NSSF, a CN response message indicative of rejection or admission to at least one network slice regarding the terminal device based on the identifier of the terminal device. The method still further comprises or initiates a step of selectively initiating registration of the terminal device. The selectivity depends on whether the CN response message indicates rejection or admission to at least one network slice regarding the terminal device.

As to a second method aspect, a method of determining rejection and admission of a terminal device to a CN of a telecommunication system is provided. The method comprises or initiates a step of receiving, at an NSSF of the CN, a CN registration request message indicative of a terminal device registration request to at least one network slice of the telecommunication system. The CN registration request message comprises an identifier of the terminal device. The method further comprises or initiates a step of sending, from the NSSF, a CN response message indicative of rejection or admission to at least one network slice regarding the terminal device based on the identifier of the terminal device.

As to a third method aspect, a method of controlling rejection and admission of a terminal device to a CN of a telecommunication system is provided. The method comprises or initiates a step of receiving, at a network slice admission control function (NSACF) of the CN from an NSSF of the CN, a network slice availability request regarding a terminal device. The network slice availability request comprises an identifier of the terminal device and at least one identifier of at least one network slice. The method further comprises or initiates a step of sending, from the NSACF to the NSSF, an indication of a network slice availability responsive to the network slice availability request. The indication is based on the identifier of the terminal device and at least one identifier of at least one network slice.

Without limitation, for example in a 3GPP implementation, any “terminal device” may be a user equipment (UE).

The technique may be applied in the context of 3GPP New Radio (NR), according to the standard family IEEE 802.11 (Wi-Fi), in the context of wired telecommunication systems and/or satellite based telecommunication systems, or any combination thereof.

The technique may be implemented in accordance with a 3GPP specification, e.g., for 3GPP release 17. The technique may be implemented for 3GPP LTE or 3GPP NR according to a modification of the 3GPP document TS 23.502, version 17.0.0 or for 3GPP LTE or 3GPP NR according to a modification of the 3GPP document TS 23.700-40, version 17.0.0.

The terminal device and the CN of the telecommunication system may be connected via a wireless connection to at least one network node (also denoted as base station) of a radio access network (RAN) in an uplink (UL) and/or a downlink (DL) through a Uu interface. The RAN may be wirelessly and/or wiredly connected to the CN. The CN may comprise at least one AMF, the NSSF and the NSACF.

Any of the terminal devices may be a 3GPP UE or a Wi-Fi station (STA). The terminal device may be a radio device such as a mobile or portable station, a device for machine-type communication (MTC), a device for narrowband Internet of Things (NB-IoT), or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more base stations (also denoted as “network node”).

Alternatively or in addition, the terminal device may be a base station. The base station may encompass any station that is configured to provide radio access to any of the radio devices. The base stations may also be referred to as cell, transmission and reception point (TRP), radio access node or access point (AP). The base station may provide a data link to a host computer providing user data to a radio device or gathering user data from the radio device. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented at the control plane and/or at the user plane of the CN (e.g., a 5G CN, briefly “5GC”) of the telecommunication system.

As to another aspect, a computer program product is provided. The computer program product comprises program code portions for performing any one of the steps of the first method aspect, of the second method aspect and/or of the third method aspect disclosed herein when the computer program product is executed by one or more computing devices. The computer program product may be stored on a computer-readable recording medium. The computer program product may also be provided for download, e.g., via the telecommunication system, a radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, an access and mobility function (AMF) for handling rejection and admission of a terminal device to a CN of a telecommunication system is provided. The AMF is configured to receive a terminal device registration request indicative of the terminal device requesting access to the telecommunication system. The AMF is further configured to send, to an NSSF of the CN, a CN registration request message indicative of the terminal device registration request. The CN registration request message comprises an identifier of the terminal device. The CN registration request message is further indicative of at least one network slice of the telecommunication system. The AMF is further configured to receive, from the NSSF, a CN response message indicative of rejection or admission to at least one network slice regarding the terminal device based on the identifier of the terminal device. The AMF is still further configured to selectively initiate registration of the terminal device. The selectivity depends on whether the CN response message indicates rejection or admission to at least one network slice regarding the terminal device.

The AMF may be configured to perform any one of the steps of the first method aspect.

As to a second device aspect, an NSSF for determining rejection and admission of a terminal device to a CN of a telecommunication system is provided. The NSSF is configured to receive a CN registration request message indicative of a terminal device registration request to at least one network slice of the telecommunication system. The CN registration request message comprises an identifier of the terminal device. The NSSF is further configured to send a CN response message indicative of rejection or admission to at least one network slice regarding the terminal device based on the identifier of the terminal device.

The NSSF may be configured to perform any one of the steps of the second method aspect.

As to a third device aspect, an NSACF for controlling rejection and admission of a terminal device to a CN of a telecommunication system is provided. The NSACF is configured to receive, from an NSSF of the CN, a network slice availability request regarding a terminal device. The network slice availability request comprises an identifier of the terminal device and at least one identifier of at least one network slice. The NSACF is further configured to send, to the NSSF, an indication of a network slice availability responsive to the network slice availability request. The indication is based on the identifier of the terminal device and is further based on at least one identifier of at least one network slice.

The NSACF may be configured to perform any one of the steps of the third method aspect.

As to a further first device aspect, an AMF is provided. The AMF comprises processing circuitry (e.g., at least one processor and a memory). Said memory comprises instructions executable by said at least one processor whereby the AMF is operative to perform any one of the steps of the first method aspect.

As to a further second device aspect, an NSSF is provided. The NSSF comprises processing circuitry (e.g., at least one processor and a memory). Said memory comprises instructions executable by said at least one processor whereby the NSSF is operative to perform any one of the steps of the second method aspect.

As to a further third device aspect, an NSACF is provided. The NSACF comprises processing circuitry (e.g., at least one processor and a memory).

Said memory comprises instructions executable by said at least one processor whereby the NSACF is operative to perform any one of the steps of the third method aspect.

As to a still further aspect a telecommunication system including a host computer is provided. The host computer comprises a processing circuitry configured to provide user data. The host computer further comprises a communication interface configured to forward the user data to a (e.g., cellular) access network (e.g., the RAN and/or the base station) for transmission to a UE. The UE comprises a (e.g., radio) interface and processing circuitry. The telecommunication system comprises at least one AMF of a CN. The at least one AMF is configured to execute any one of the steps of the first method aspect.

Any one of the at least one AMF, the NSSF, the NSACF, the communication system or any component of the CN for embodying the technique may further include any feature disclosed in the context of the method aspects, and vice versa. Particularly, any one of the units and modules disclosed herein may be configured to perform or initiate one or more of the steps of the method aspects.

### BRIEF DESCRIPTION OF THE DRAWINGS

Further details of embodiments of the technique are described with reference to the enclosed drawings, wherein:

FIG. 1 shows a schematic block diagram of an embodiment of an access and mobility function (AMF) for handling rejection and admission of a terminal device to a core network (CN) of a telecommunication system;

FIG. 2 shows a schematic block diagram of an embodiment of a network slice selection function (NSSF) for determining rejection and admission of a terminal device to a CN of a telecommunication system;

FIG. 3 shows a schematic block diagram of an embodiment of a network slice admission control function (NSACF) for controlling rejection and admission of a terminal device to a CN of a telecommunication system;

FIG. 4 shows a flowchart for a method of for handling rejection and admission of a terminal device to a CN of a telecommunication system, which method may be implementable by at least one AMF of FIG. 1;

FIG. 5 shows a flowchart for a method of determining rejection and admission of a terminal device to a CN of a telecommunication system, which method may be implementable by the NSSF of FIG. 2;

FIG. 6 shows a flowchart for a method of controlling rejection and admission of a terminal device to a CN of a telecommunication system, which method may be implementable by the NSACF of FIG. 3;

FIG. 7 schematically illustrates a prior art example of a method of rejecting a terminal device from a CN of a telecommunication system after performing authentication, registration and session management (SM) policy control by a legacy AMF;

FIG. 8 schematically illustrates an example of a method of handling, determining, and controlling the rejecting of a terminal device from a CN of a telecommunication system without performing authentication, registration and/or SM policy control by any one of at least one AMF, which method may be performed by the AMF of FIG. 1, the NSSF of FIG. 2, and the NSACF of FIG. 3, respectively;

FIG. 9 schematically illustrates an example of a method of handling, determining, and controlling the admitting of a terminal to a CN of a telecommunication system, which method may be performed by the AMF of FIG. 1, the NSSF of FIG. 2, and the NSACF of FIG. 3, respectively;

FIG. 10 shows a schematic block diagram of an AMF embodying the AMF of FIG. 1;

FIG. 11 shows a schematic block diagram of an NSSF embodying the NSSF of FIG. 2;

FIG. 12 shows a schematic block diagram of an NSACF embodying the NSACF of FIG. 3;

FIG. 13 schematically illustrates an example telecommunication network connected via an intermediate network to a host computer;

FIG. 14 shows a generalized block diagram of a host computer communicating via a base station or radio device functioning as a gateway with a user equipment over a partially wireless connection; and

FIGS. 15 and 16 show flowcharts for methods implemented in a telecommunication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other telecommunication technique, in particular any wired, satellite and/or radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

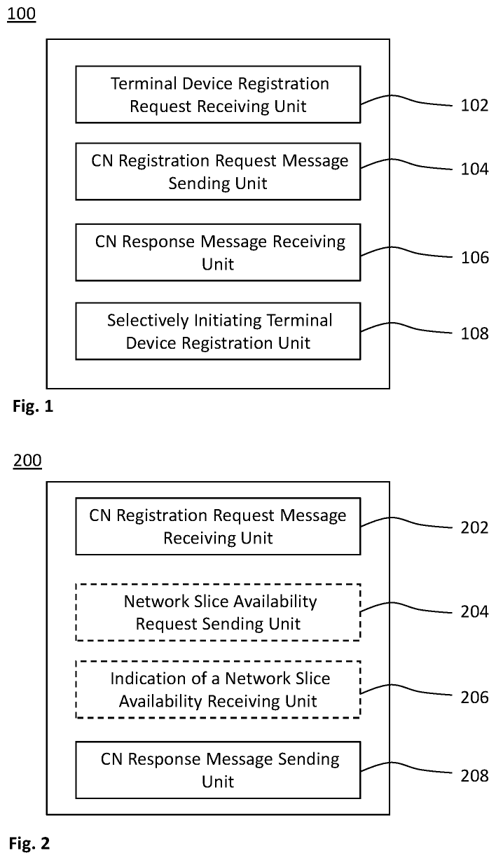

FIG. 1 schematically illustrates a block diagram of an embodiment of an access and mobility function (AMF) for handling rejection and admission of a terminal device to a core network (CN) of a telecommunication system. The AMF is generically referred to by reference sign 100.

The AMF 100 comprises a terminal device registration request receiving unit 102 that is configured to receive a terminal device registration request indicative of the terminal device requesting access to the telecommunication system.

The AMF 100 further comprises a CN registration request message sending unit 104 that is configured to send, to a network slice selection function (NSSF) of the CN, a CN registration request message indicative of the terminal device registration request. The CN registration request message comprises an identifier of the terminal. The CN registration request message is further indicative of at least one network slice of the telecommunication system.

The AMF 100 further comprises a CN response message receiving unit 106 that is configured to receive, from the NSSF, a CN response message indicative of rejection or admission to at least one network slice regarding the terminal device based on the identifier of the terminal device.

The AMF 100 still further comprises a selectively initiating terminal device registration unit 108 that is configured to selectively initiate registration of the terminal device. The selectivity depends on whether the CN response message indicates rejection or admission to at least one network slice regarding the terminal device.

The AMF 100 may be further configured to perform any one of the steps of the first method 400 detailed below.

Any of the units of the AMF 100 may be implemented by modules configured to provide the corresponding functionality.

FIG. 2 schematically illustrates a block diagram of an embodiment of a network slice selection function (NSSF) for determining rejection and admission of a terminal device to a CN of a telecommunication system. The NSSF is generically referred to by reference sign 200.

The NSSF 200 comprises a CN registration request message receiving unit 202 configured to receive a CN registration request message indicative of a terminal device registration request to at least one network slice of the telecommunication system. The CN registration request message comprises an identifier of the terminal device.

The NSSF 200 further comprises a CN response message sending unit 208 configured to send a CN response message indicative of rejection or admission to at least one network slice regarding the terminal device based on the identifier of the terminal device.

Optionally, the NSSF 200 comprises a network slice availability request sending unit 204 that is configured to send, from the NSSF, a network slice availability request to a network slice admission control function (NSACF) regarding the terminal device. The network slice availability request comprises the identifier of the terminal device and at least one identifier of at least one network slice.

Further optionally, the NSSF 200 comprises an indication of a network slice availability receiving unit 206 that is configured to receive, at the NSSF from the NSACF, an indication of a network slice availability responsive to the network slice availability request. The indication is based on the identifier of the terminal device and at least one identifier of at least one network slice.

The NSSF 200 may be further configured to perform any one of the steps of the second method 500 detailed below.

Any of the units of the device 200 may be implemented by modules configured to provide the corresponding functionality.

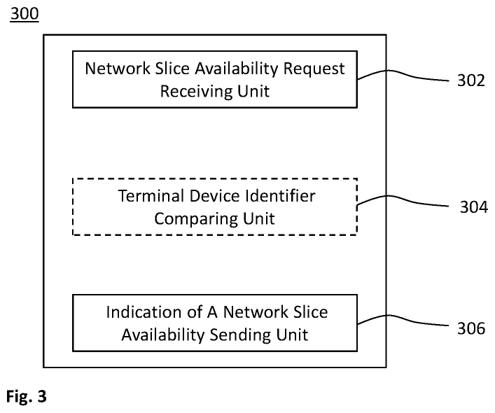

FIG. 3 schematically illustrates a block diagram of an embodiment of a network slice admission control function (NSACF) for controlling rejection and admission of a terminal device to a CN of a telecommunication system. The NSACF is generically referred to by reference sign 300.

The NSACF 300 comprises a network slice availability request receiving unit 302 configured to receive, from an NSSF (e.g., the NSSF 200) of the CN, a network slice availability request regarding a terminal device. The network slice availability request comprises an identifier of the terminal device and at least one identifier of at least one network slice.

The NSACF 300 further comprises an indication of a network slice availability sending unit 306 configured to send, to the NSSF (e.g., the NSSF 200), an indication of a network slice availability responsive to the network slice availability request. The indication is based on the identifier of the terminal device and at least one identifier of at least one network slice.

Optionally, the NSACF 300 comprises a terminal device identifier comparing unit 304 configured to compare the identifier of the terminal device, for which network slice availability is requested, to a list of identifiers of at least one or each of the registered terminal devices for the at least one network slice. The list of identifiers may be comprised in a counter of registered terminal devices. The counter may be associated to one network slice of the telecommunication network. Alternatively or in addition, each one of a group of network slices may comprise a (e.g., independent) counter.

The NSACF 300 may be further configured to perform any one of the steps of the third method aspect 600 detailed below.

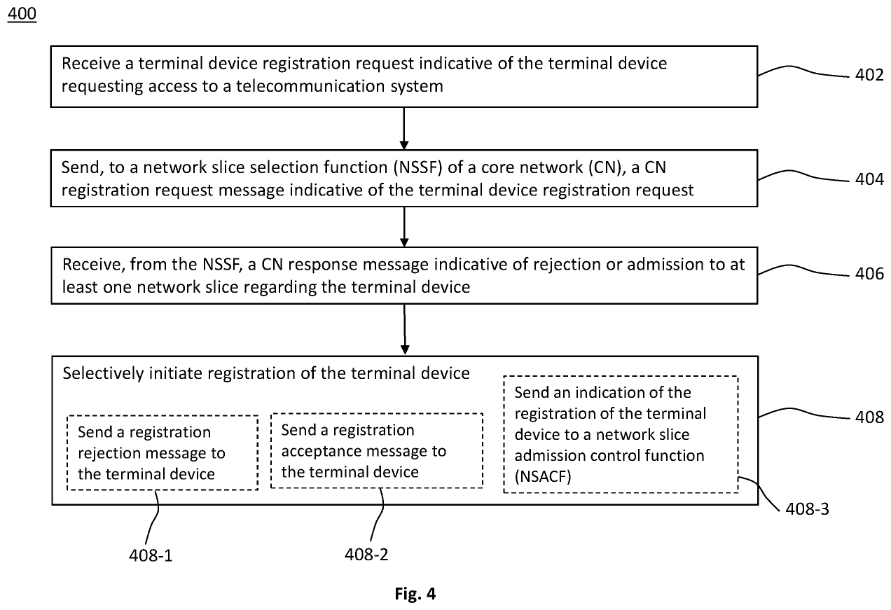

FIG. 4 shows an example flowchart for a method 400 of handling rejection and admission of a terminal device to a CN of a telecommunication system.

In a step 402, a terminal device registration request indicative of the terminal device requesting access to the telecommunication system is received. In a step 404, a CN registration request message indicative of the terminal device registration request is sent to an NSSF (e.g., NSSF 200) of the CN. The CN registration request message comprises an identifier of the terminal device. The CN registration request message is further indicative of at least one network slice of the telecommunication system. In a step 406, a CN response message indicative of rejection or admission to at least one network slice regarding the terminal device based on the identifier of the terminal device is received from the NSSF (e.g., NSSF 200). In a step 408, registration of the terminal device is selectively initiated. The selectivity depends on whether the CN response message indicates rejection or admission to at least one network slice regarding the terminal device.

Optionally, in a substep 408-1 of the step 408, a registration rejection message is sent to the terminal device if the received (e.g., in step 406) CN response message is indicative of rejection of the terminal device.

Further optionally, in a substep 408-2 of the step 408, a registration acceptance message is sent to the terminal device if the received (e.g., in the step 406) CN response message is indicative of admission of the terminal device to at least one network slice. Optionally, the registration acceptance message is sent in the step 408-2 (e.g., only) if at least one of authentication, registration and session management, SM, policy control of the terminal device is successfully performed by an AMF (e.g., AMF 100), of the CN.

Still further optionally, in a substep 408-3 of the step 408, if the received (e.g., in step 406) CN response message is indicative of admission of the terminal device, an indication of the initiation of the registration of the terminal device is sent to an NSACF (e.g., NSACF 300).

The method 400 may be performed by at least one AMF 100. For example, the units 102, 104, 106 and 108 may perform the steps 402, 404, 406 and 408, respectively.

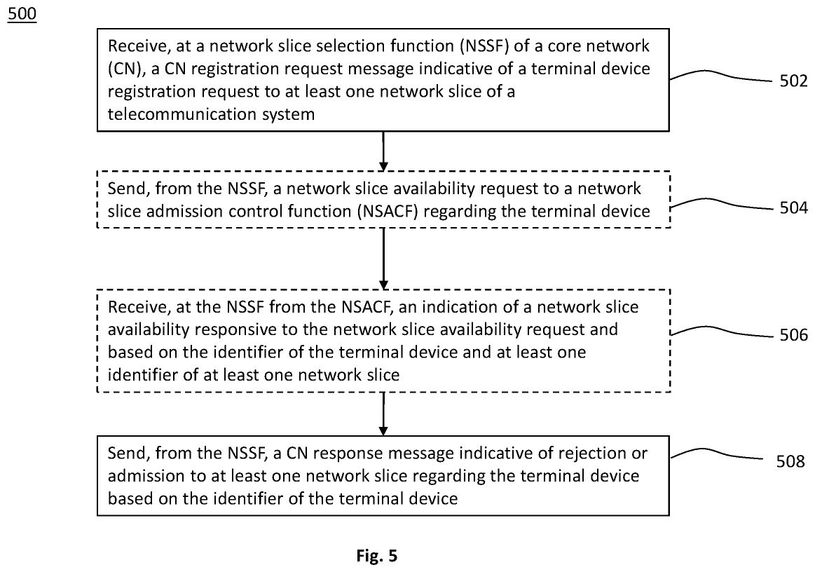

FIG. 5 shows an example flowchart for a method 500 of determining rejection and admission of a terminal device to a CN of a telecommunication system.

In a step 502, at an NSSF (e.g., NSSF 200) of the CN, a CN registration request message indicative of a terminal device registration request to at least one network slice of the telecommunication system is received. The CN registration request message comprises an identifier of the terminal device. In a step 508, a CN response message indicative of rejection or admission to at least one network slice regarding the terminal device based on the identifier of the terminal device is sent from the NSSF (e.g., NSSF 200).

Optionally, in a step 504, a network slice availability request is sent, from the NSSF (e.g., NSSF 200) to an NSACF (e.g., NSACF 300), regarding the terminal device. The network slice availability request comprises the identifier of the terminal device and at least one identifier of at least one network slice.

Further optionally, in a step 506, an indication of a network slice availability is received, at the NSSF (e.g., NSSF 200) from the NSACF (e.g., NSACF 300), responsive to the network slice availability request. The indication is based on the identifier of the terminal device and at least one identifier of at least one network slice.

The method 500 may be performed by the NSSF 200. For example, the units 202 and 208 and the optional units 204 and 206 may perform the steps 502 and 508 and the optional steps 504 and 506, respectively.

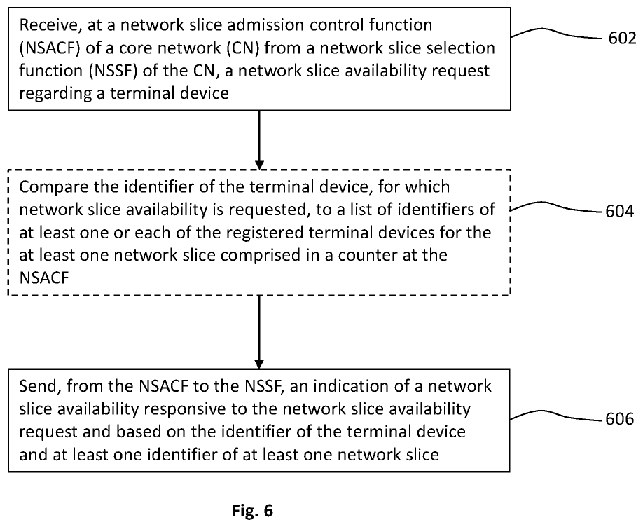

FIG. 6 shows an example flowchart of a method 600 of controlling rejection and admission of a terminal device to a CN of a telecommunication system.

In a step 602, a network slice availability request regarding a terminal device is received at an NSACF (e.g., NSACF 300) of the CN from an NSSF (e.g., NSSF 200) of the CN. The network slice availability request comprises an identifier of the terminal device and at least one identifier of at least one network slice. In a step 606, an indication of a network slice availability is sent from the NSACF (e.g., NSACF 300) to the NSSF (e.g., NSSF 200) responsive to the network slice availability request. The indication is based on the identifier of the terminal device and at least one identifier of at least one network slice.

Optionally, in a step 604, the identifier of the terminal device, for which network slice availability is requested, is compared to a list of identifiers of at least one or each of a plurality of registered terminal devices for the at least one network slice. The list of identifiers in comprised in a counter at the NSACF (e.g., the NSACF 300).

The method 600 may be performed by the NSACF 300. For example, the units 302 and 306 and the optional unit 304 may perform the steps 602 and 606 and the optional step 604, respectively.

In any aspect, an (e.g., early) rejection and/or (e.g., early) admission control (e.g., as to the at least one network slice) in the telecommunication system (also denoted as “network”) may be performed. (E.g., early) rejection and/or (e.g., early) admission control may be performed at an early stage of a registration attempt to the CN (e.g., a 5GC registration), e.g., when at least one network slice is selected for the registration of the terminal device.

The (e.g., early) rejection and/or (e.g., early) admission control may comprise at least one of the following aspects. At least one AMF (e.g., AMF 100) may be based on a local policy (e.g. per network slice and/or per network slice assistance information, NSSAI) to indicate in the network slice selection procedure the support of “early rejection and/or early admission control” (also denoted as “early admission control and/or rejection”). The at least one AMF (e.g., AMF 100) may also include the identity (e.g., an identifier) of the terminal device (e.g., UE). The identifier of the terminal device may comprise a subscription permanent identifier (SUPI) and/or an international mobile subscriber identity (IMSI) of the terminal device.

Alternatively or in addition, if the NSSF (e.g., NSSF 200) is co-located with the NSACF (e.g., NSACF 300), e.g. they share (for example internally) information regarding the (e.g., total or overall) number and/or identifiers of terminal device (e.g., UEs) registered per network slice and regarding (e.g., operator-defined and/or predetermined) threshold numbers (also denoted as “limits” or “quotas”), and the NSSF (e.g., NSSF 200) receives from the AMF (e.g., AMF 100) the indication of “early rejection and/or early admission control” (also denoted as “early admission control and/or rejection”), it checks if the requested network slices (e.g., provided in terms of NSSAIs or single NSSAIs, S-NSSAIs) have reached the (e.g., operator-defined and/or predetermined) threshold numbers of terminal devices (e.g., UEs) registered.

Alternatively or in addition, if the NSSF (e.g., NSSF 200) is not co-located with the NSACF (e.g., NSACF 300), the NSSF (e.g., NSSF 200) requests the information from the NSACF (e.g., NSACF 300), by including a request “check limit and/or threshold number”, which allows the NSSF (e.g., NSSF 200) to request for the information, but keeping the number of terminal device (e.g. UEs) unmodified, e.g., since it is not known at the step of requesting information whether the registration of the terminal device (e.g., UE) will succeed. Requesting the information may correspond to sending the network slice availability request.

Further alternatively or in addition, the NSACF (e.g., NSACF 300) may return the threshold information (e.g., as “reached” and/or “not reached”) if the indication is received. Returning the threshold information may correspond to sending the indication of the network slice availability.

Still further alternatively or in addition, when the NSSF (e.g., NSSF 200) determines (e.g., via a co-located NSACF, e.g., NSACF 300, or based on the response of a non-co-located NSACF, e.g., NSACF 300) that no new CN, e.g., 5GC, registrations are allowed in the requested network slices (e.g., determined by corresponding NSSAI(s)), the NSSF (e.g., NSSF 200) returns an error (e.g., as “quota exceeded”). Returning the error by the NSSF may correspond to sending a CN response message indicative of rejection of the terminal device.

Further alternatively in on addition, if the requested at least one network slice (e.g., provided in terms of one or more NSSAIs and/or S-NSSAIs) are out of quota (e.g., no more terminal devices, e.g., UEs, are allowed to register), the AMF (e.g., AMF 100) may return an error to the terminal device, e.g., UE, so that the terminal device, e.g., UE, is aware that the requested at least one network slice (e.g., provided in terms of at least one NSSAI and/or S-NSSAI) is out of quota, with possibly a back-off timer so that the terminal device, e.g., UE, can attempt admission to the same at least one network slice (e.g., provided in terms of at least one NSSAI and/or S-NSSAI) and/or can attempt admission to at least one different network slice (e.g., provided in terms of at least one NSSAI and/or S-NSSAI different from the one or more NSSAI and/or S-NSSAI of a previous attempt). Returning the error by the AMF may correspond to sending the registration rejection message.

Further alternatively in on addition, if the quota is not exceeded, the NSSF (e.g., NSSF 200) may return a successful response, indicating that (e.g., early) rejection and/or (e.g., early) admission control has been performed. Returning the successful response by the NSSF may correspond to sending a CN response message indicative of admission of the terminal device to at least one network slice.

Still further alternatively in on addition, when the AMF (e.g., AMF 100) returns a registration accept, the AMF (e.g., AMF 100) may send (e.g., in parallel) the addition of the terminal device (e.g., UE) to the NSACF (e.g., NSACF 300), for example without performing (e.g., early) rejection and/or (e.g., early) admission control. Returning the registration accept by the AMF may correspond to sending the registration acceptance message. Alternatively or in addition, sending the addition of the terminal device by the AMF may correspond to sending the indication of the initiation of the registration of the terminal device.

By the methods 400, 500 and/or 600, the network slice admission control (e.g., regarding a maximum number of terminal devices, e.g., UEs, registered in a network slice) can be performed at an early (e.g., the first) stage of the CN (e.g., 5GC) registration, e.g., when the network slice is to be selected.

Alternatively or in addition, by the methods 400, 500 and/or 600 useless procedures of authentication and/or registration attempts can be spared and/or saved when the slice quota has been exceeded. Alternatively or in addition, signaling overhead within the CN can be reduced and latency of rejection and/or admission of the terminal device to the CN can be mitigated.

Further alternatively or in addition, by the methods 400, 500 and/or 600, a functioning of the NSSF (e.g., NSSF 200) can be optimized based on the identifier of the terminal device (e.g., UE identity). For example, a given terminal device (e.g., UE) received at the NSSF (e.g., NSSF 200), before checking network slice quota, can be subject to no admission control, hence the NSSF (e.g., NSSF 200) and/or NSACF (e.g., NSACF 300), even if the network slice quota has been reached, can grant access for the related terminal device (e.g., UE), e.g., if the related terminal device is associated with a priority exceeding a predefined priority threshold. The priority threshold may relate to instant admission of the terminal device to at least one network slice, if the priority of the terminal device exceeds the predefined priority threshold.

The terminal device may comprise a radio device. The radio device may alternatively be denoted as user equipment (UE). Alternatively or in addition, the terminal device may comprise a wired device that is connected to, e.g. not part of, the CN. E.g., the terminal device may comprise a router providing (e.g., radio) access to the telecommunication system for a radio device.

The telecommunication system may comprise the CN and at least one access network. The at least one access network may comprise a radio access network (RAN), a (e.g., non-trusted) Wireless Local Access Network (WLAN) and/or a Wireline 5G Access Network (W-5GAN).

Alternatively or in addition, the telecommunication system may comprise at least one of a wireless communication system, a wired communication system and a satellite communication system, or any combination of communication systems.

The wireless communication system may comprise at least one RAN. The RAN may comprise at least one radio access technology (RAT). For example, the RAN may comprise at least two different RATs, e.g. at least one according to a 3GPP standard and at least another one according to a Wi-Fi standard.

A network slice may comprise a logical network providing specific network capabilities and network characteristics, e.g. in terms of a quality of service (QOS), spatial resources and/or frequency resources.

The terminal device registration request may be indicative of the terminal device requesting access to the telecommunication system. Requesting access to the telecommunication system may, e.g. implicitly, imply requesting access to at least one network slice of the telecommunication system. The at least one network slice may, e.g. implicitly, be pre-selected and/or determined based on a location of the terminal device. Alternatively or in addition, the at least one network slice may, e.g. implicitly, be pre-selected and/or determined based on a service type requested by the terminal device.

The CN registration request message may also be denoted as CN network slice selection assistance request message. Alternatively or in addition, the CN registration request message may comprise a request for assistance for selecting at least one network slice for registration of the terminal device.

The terminal device registration request and/or the CN registration request message may comprise at least one NSSAI. Alternatively or in addition, the terminal device registration request and/or the CN registration request message may comprise at least one S-NSSAI. For example, the terminal device and/or the CN may be configured to support a predetermined number, e.g., up to eight S-NSSAIs, simultaneously for the terminal device.

The registration request, the at least one NSSAI and/or the at least one S-NSSAI may comprise a slice/service type (SST). Alternatively or in addition, the registration request may comprise a slice differentiator (SD) differentiating amongst multiple network slices of the same SST.

The CN registration request message may comprise an indication of a capability of (e.g., early) rejection and/or (e.g., early) admission control. (E.g., early) rejection and/or (e.g., early) admission control may refer to, e.g., rejecting the terminal device without (e.g., anteriorly) attempting and/or initiating to authenticate and/or to register the terminal device to the (e.g., CN of the) telecommunication system, and/or without performing session management (SM) policy control.

Alternatively or in addition, the CN registration request message may comprise the identifier of the terminal device. The identifier of the terminal device may in particular comprise a SUPI, e.g., an IMSI.

The first method 400 may be performed by at least one access and mobility management function (briefly also “access and mobility function” or AMF, e.g., AMF 100). Alternatively or in addition, the method may be performed by at least two AMFs (e.g., two AMFs 100). For example, the steps of receiving a terminal device registration request and sending a CN registration request message may be performed by a first AMF (e.g., a first embodiment of the AMF 100), and the steps of receiving a CN response message and selectively initiating registration of the terminal device may be performed by a second AMF (e.g., a second embodiment of the AMF 100), e.g., if the at least one network slice to which the terminal device is admitted is handled by the second AMF (e.g., the second embodiment of the AMF 100). Alternatively or in addition, the method may be performed by at least two AMFs (e.g., two AMFs 100) in case of mobility scenarios, e.g., if the terminal device moves across spatially separated network slices.

A network slice function may comprise the NSSF (e.g., NSSF 200) and the NSACF (e.g., NSACF 300). The NSSF (e.g., NSSF 200) may be configured to select at least one network slice. Alternatively or in addition, the NSACF (e.g., NSACF 300) may be configured to control admission to at least one network slice, e.g., to the at least one network slice selected by the NSSF (e.g., NSSF 200).

The CN registration request message may be received at the NSSF (e.g., NSSF 200), e.g. in steps 502 and/or 404 from the AMF (e.g., AMF 100). Alternatively or in addition, the CN response message may be sent by the NSSF (e.g., NSSF 200), e.g. in steps 508 and/or 406 to the AMF (e.g., AMF 100).

The CN response message may be indicative of rejection of the terminal device. The rejection of the terminal device may comprise a rejection and/or a failure to register the terminal device in the at least one network slice of the terminal device registration request and/or in any network slice of the telecommunication system. Alternatively or in addition, the rejection of the terminal device may comprise a failure to steer the terminal device to at least one network slice of the terminal device registration request and/or to any network slice of the telecommunication system.

Alternatively or in addition, the CN response message may be indicative of admission of the terminal device to at least one network slice. The at least one network slice, to which the terminal device is admitted, may comprise the at least one network slice of the terminal device registration request. Alternatively or in addition, the at least one network slice to which the terminal device is admitted may be different from the at least one network slice of the terminal device registration request. For example, the terminal device may request registration to one network slice using an NSSAI or S-NSSAI comprising both SST and SD of the network slice, but the terminal device may be admitted to another network slice having the same SST, but a different SD from the one requested.

Selectively initiating registration of the terminal device in the step 408 may comprise sending a registration rejection message to the terminal device if the CN response message is indicative of rejection of the terminal device to the at least one network slice and/or to any network slice of the telecommunication system. Alternatively or in addition, selectively initiating registration of the terminal device may comprise sending a registration acceptance message to the terminal device if the CN response message is indicative of admission of the terminal device to at least one network slice.

By the selectivity of initiating registration of the terminal device, latency may be mitigated and/or signaling overhead may be reduced.

The terminal device registration request of the method 400 may comprise an indication of at least one network slice and/or a slice and/or service type (SST) of at least one network slice. The SST may also be referred to as slice/service type.

The terminal device registration request may further comprises an indication of an SD of the at least one network slice.

The terminal device registration request may comprise (e.g., at least one) NSSAI and/or (e.g., at least one) S-NSSAI.

The identifier of the terminal device may be indicative of a priority of the terminal device.

The priority of the terminal device may comprise a service level agreement (SLA) and/or a QoS granted to the terminal device. In case of high occupancy and/or high demand for a network slice, a terminal device of a high priority may be given preference for admission (e.g., for the requested registration), while a terminal device of a low priority may be disadvantaged and/or its registration request may be rejected.

The CN registration request message may comprises a tracking area identity (TAI) associated with the terminal device and/or with at least one network slice indicated in the terminal device registration request.

The CN registration request message may comprise an indication that (e.g., early) rejection and/or (e.g., early) admission control is supported. (E.g., early) rejection may comprise rejection of the terminal device before initiating authentication and/or registration of the terminal device and/or before performing SM policy control.

The authentication and/or registration and/or SM policy control may be initiated by the AMF (e.g., AMF 100) if the received CN response message is indicative of admission of the terminal device.

Sending the registration rejection message to the terminal device in the step 408-1 may trigger and/or initialize a back-off timer at the terminal device. Upon expiry of the back-off timer, the terminal device may send a further registration request requesting access to the same and/or to a different at least one network slice of the telecommunication system.

Sending the registration acceptance message to the terminal device may comprise performing, e.g. by the AMF 100, authentication, registration and/or SM policy control.

The registration acceptance message may comprise an indication of the at least one network slice to which the terminal device is admitted.

The method 400 may be performed by at least one AMF (e.g., AMF 100).

The network slice availability request (e.g., as sent in the step 504 and/or received in a step 602) may comprise a request on the availability of at least one network slice indicated in the received CN registration request message. Alternatively or in addition, the indication of the network slice availability may comprise an indication of at least one network slice that is available and/or an indication that no network slice is available. Further alternatively or in addition, the at least one network slice that is available may be the same as and/or may differ from the at least one network slice indicated in the received CN registration request message.

The NSSF (e.g., NSSF 200) and the NSACF (e.g., NSACF 300) may be spaced apart. Alternatively or in addition, the NSSF (e.g., NSSF 200) and the NSACF (e.g., NSACF 300) may be co-located, e.g. in a network slice function comprising the NSSF (e.g., NSSF 200) and the NSACF (e.g., NSACF 300). Further alternatively or in addition, the steps of sending the network slice availability request and receiving the indication of the network slice availability may be performed internally within the network slice function, e.g. if the NSSF (e.g., NSSF 200) and the NSACF (e.g., NSACF 300) are co-located.

The identifier of the terminal device may comprise a SUPI, e.g. an IMSI, for any one of the first method 400, the second method 500 and the third method 600.

The second method 500 may further comprise or initiate any one of the steps of the first method aspect 400, or steps corresponding thereto. Alternatively or in addition, the second method 500 may comprise any one of the aspects and features of the first method aspect 400, or aspects and features corresponding thereto. For example, any one of terminal registration request, the CN registration request message, the network slice availability request, the indication of the network slice availability and the CN response message and may comprise at least one NSSAI and/or at least one S-NSSAI.

The NSACF 300 may comprise a counter of registered terminal devices for each of the at least one network slice. The counter of registered terminal devices may further comprise a list of identifiers of (e.g., at least one or each of the) registered terminal devices for each of the at least one network slice.

The list of identifiers of (e.g., at least one or each of the) registered terminal devices associated with a counter for a network slice may comprise any identifier at most once. Alternatively or in addition, the list of identifiers associated with a counter for a network slice may not comprise any identifier twice or multiple times.

An identifier of the terminal device, for which network slice availability is requested, may be compared in a step 604 to the list of identifiers of (e.g., at least one or each of the) registered terminal devices for the at least one network slice. The counter of registered terminal devices may be incremented and/or the identifier of the terminal device, for which network slice is requested, may be added to the list of identifiers if the comparison in the step 604 indicates that the identifier of the terminal device, for which network slice availability is requested, was not comprised in the list of identifiers. Alternatively or in addition, the counter of registered terminal devices may not or need not be incremented and/or the list of identifiers may be maintained if the comparison in the step 604 indicated that the identifier of the terminal device, for which network slice availability is requested, was comprised in the list of identifiers.

The NSACF (e.g., NSACF 300) may further comprise a predetermined threshold number (also denoted as “limit” and/or “quota”) of registered terminal devices for the at least one or each network slice of the telecommunication system. The indication of the network slice availability may comprises an indication if, based on the counter of registered terminal devices, the predetermined threshold number of registered terminal devices of the at least one network slice is reached and/or exceeded.

The predetermined threshold number may be comprised and/or stored in the NSACF (e.g., NSACF 300).

The predetermined threshold number of registered terminal devices may be independently predetermined for the at least one or each network slice.

The predetermined threshold number may be predetermined by an operator of the network slice, by an operator of the CN and/or by an operator of the telecommunication system. The predetermined threshold number may be specific or dedicated to each network slice. Alternatively or in addition, the predetermined threshold number may depend on the SST, and optionally the SD, of each network slice.

The indication of the network slice availability may be indicative of admission of the terminal device to the at least one network slice if the predetermined threshold number is not reached and/or not exceeded. Alternatively or in addition, the indication of the network slice availability may be indicative of rejection of the terminal device if the predetermined threshold number is reached and/or exceeded.

The indication of the network slice availability may be indicative of admission of the terminal device to the at least one network slice if the predetermined threshold number is reached and/or exceeded and if a priority of the terminal device exceeds a predefined priority threshold.

The predetermined threshold number may correspond to a total number of terminal devices admissible for simultaneous registration. The predetermined threshold number may comprise a sum of a predetermined low-priority threshold number and a predetermined high-priority threshold number. Low priority may comprise any priority below and/or up to the predefined priority threshold. Alternatively or in addition, high priority may comprise any priority exceeding the predefined priority threshold. Alternatively or in addition, a predetermined percentage, e.g. 20%, of the predetermined threshold number, may be reserved to terminal devices exceeding the predefined priority threshold.

The NSSF (e.g., NSSF 200) and NSACF (e.g., NSACF 300) may be co-located at a network slice function. Any one of the steps of the third method 600 may be performed locally at the network slice function.

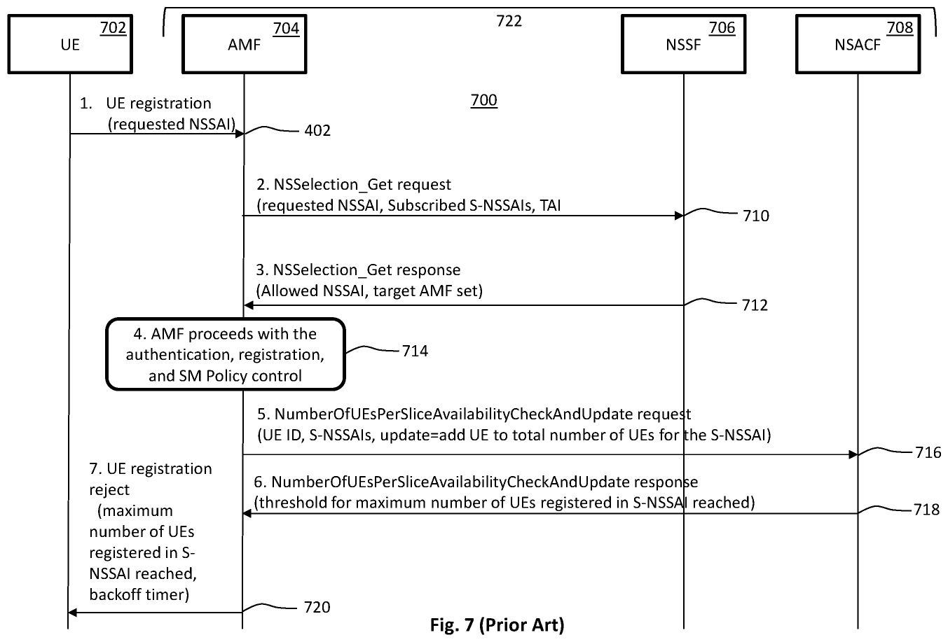

FIG. 7 provides an example implementation of a legacy network slice access and 5G core network (5GC) registration procedure in accordance with the 3GPP standard according to the documents TS 23.502, version 17.0.0 and TS 23.700-40, version 17.0.0 “Study on enhancement of network slicing; Phase 2” in case the registration of the terminal device (e.g., UE 702) is rejected. The legacy CN 722 of the telecommunication system 700 comprises AMF 704, NSSF 706 and NSACF 708.

In the step 402, a terminal device registration request in received from terminal device 702 at AMF 704. In a subsequent step 710, AMF 704 sends a CN registration request message (also denoted as “NSSelection_Get request”) to NSSF 706. The legacy CN registration request message comprises at least one requested NSSAI, subscribed S-NSSAIs and a TAI. In a step 712, NSSF 706 sends a CN response message (also denoted as “NSSelection_Get response”) to AMF 704. The legacy CN response message comprises at least one allowed NSSAI and a target AMF (e.g., AMF 704) set. In a step 714, AMF 704 proceeds with the authentication, registration and SM policy control of the terminal device 702. Subsequently, in a step 716, AMF 704 sends a request for an availability check and update of the number of terminal devices 702 per network slice to NSACF 708, to which NSACF 708 returns a response in a step 718. The legacy availability check and update request comprises an identifier of the terminal device 702, at least one S-NSSAI and an instruction to increase the total number of terminal devices in a counter of the at least one S-NSSAI. The legacy response comprises and indication in case a predetermined threshold number of registered terminal devices per S-NSSAI is reached and/or exceeded. In case the predetermined threshold number is reached and/or exceeded, in a step 720, AMF 704 sends a registration rejection message to the terminal device 702. A back-off timer may be started or restarted at the terminal device 702 upon reception of the registration rejection message in the step 720.

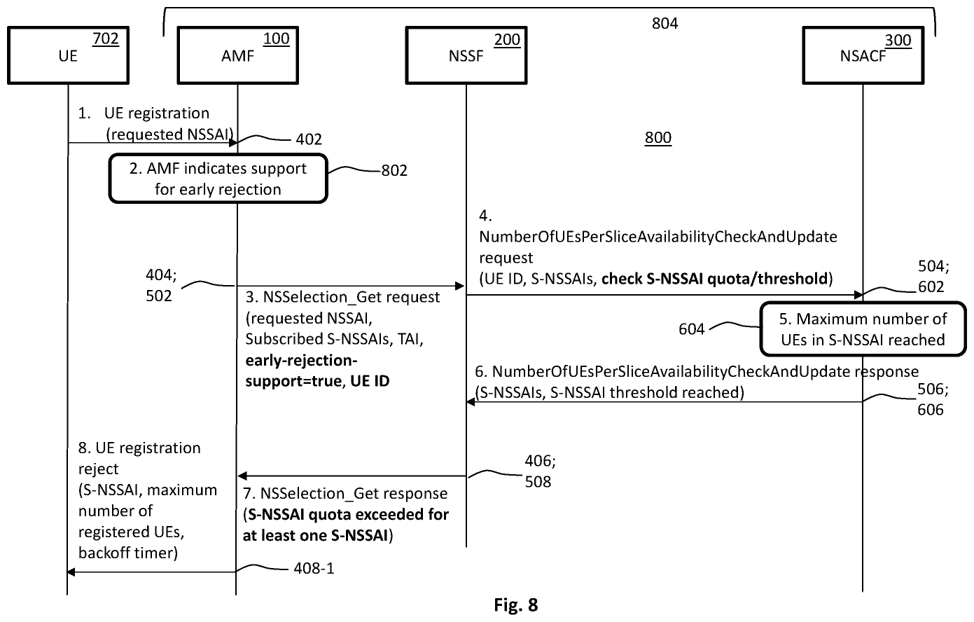

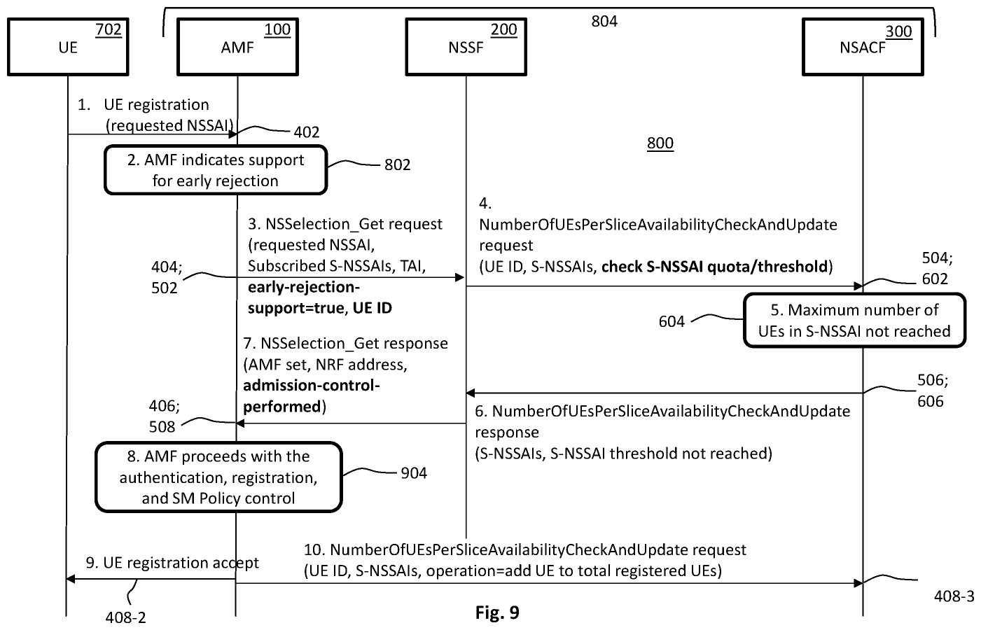

FIGS. 8 and 9 show example implementations of the first method 400, the second method 500 and the third method 600 in case of rejection and admission of a terminal 702 to (e.g., to at least one network slice of) the CN 804 of the telecommunication system 800, respectively. The CN 804 comprises at least one AMF 100, NSSF 200 and NSACF 300.

In the step 402, a terminal device registration request is received at AMF 100 from terminal device 702 (e.g., UE 702). The at least one network slice requested by the terminal device 702 may be subject to admission control, e.g., in terms of a predetermined threshold number comprising a maximal allowed number of terminal devices 702 registered per network slice.

In an optional step 802, AMF 100 indicates support of (e.g., early) rejection and/or admission control, e.g., before attempting authentication, registration and/or SM policy control for the terminal device 702. The indication of (e.g., early) rejection and/or admission control may be based on a local policy of AMF 100.

At reference sign 404 and/or 502, a CN registration request message (also denoted as “NSSelection_Get request” or “request for slice selection assistance”) is sent from AMF 100 and received at NSSF 200. The CN registration request message comprises at least one requested NSSAI, one or more subscribed S-NSSAIs, at least one TAI, an identifier (e.g., UE ID) of the terminal device 702 and optionally a flag indicative of the support or (e.g., early) rejection by AMF 100.

The steps 404 and 502 deviate from conventional AMF procedures, e.g., if AMF 704 of FIG. 7 can support a network slice, it does not forward any identifier of the terminal device 702 to NSSF 706 and/or does (e.g., simultaneously) not query NSSF 706 for terminal device 702 (e.g., UE) registration.

By contrast, if in step 802 it is verified, or if it is known by other NFs of the CN 804 such as the NSSF 200, that AMF 100 supports (e.g., early) rejection and/or (e.g., early) admission control or AMF 100, in the step 404 and/or 502, AMF 100 queries NSSF 200 for the terminal device 702 (e.g., UE) registration.

Subsequently, at reference sign 504 and/or 603, NSSF 200 sends a network slice availability request (also denoted as “NumberOfUEsPerSliceAvailabilityCheckAndUpdate request”), which is received by NSACF 300.

Alternatively or in addition, since the indication of (e.g., early) rejection and/or (e.g., early) admission control may be received at step 502 and/or 404, NSSF 200 may check internally (e.g., if NSSF 200 and NSACF 300 are co-located) whether the terminal device 702 (e.g., UE) is counted as registered already in the at least one network slice of the CN registration request.

Further alternatively or in addition, if NSACF 300 is not co-located with NSSF 200, NSSF 200 may request NSACF 300 to check whether the predetermined threshold number of registered terminal devices has been reached. Such a request is conventionally not included. If the terminal device 702 (e.g., UE) is not counted yet, and the predetermined threshold number has been reached for the at least one network slice, NSACF 300 may return a “threshold reached” response.

Alternatively or in addition, conventionally, a request for an availability check and update of the number of terminal devices 702 per network slice to NSACF 708 as exemplified at reference sign 716 comprises having registered the terminal device 702 at AMF 704 at reference sign 714, which requires de-registering the terminal device 702 from AMF 704 and/or from NSACF 708 in case the predetermined threshold number has been reached and/or exceeded as exemplified at reference sign 718.

By the methods 400, 500 and 600, first registering the terminal device 702 and then de-registering again from AMF 100 and/or NNSACG 300 in case the predetermined threshold number has been reached and/or exceeded is avoided.

The comparison of the identifier of the terminal device 702 with the list of identifiers of registered terminal devices is indicated at reference sign 604 in FIGS. 8 and 9 per network slice and/or per S-NSSAI.

NSSF 200 may determine multiple allowed network slices. The network slice availability request may comprise one message exchanged between NSSF 200 and NSACF 300 for a plurality of network slices and/or a plurality of S-NSSAIs. Alternatively or in addition, NSSF 200 and NSACF 300 may exchange multiple messages regarding different ones of the plurality of network slices and/or the plurality of S-NSSAIs. NSSF 200 may narrow down candidate allowed network slices according to NSACF 300 response.

Conventionally, the terminal device 702 and/or AMF 704 perform the registration procedures at steps 402 and 714 for a specific network slice. In case this specific network slice is not available (e.g., due to the predetermined threshold number of registered devices already being exceeded), the rejection of step 720 is returned, even though another network slice might be available to serve the terminal device 702.

By the methods 400, 500 and/or 600, a plurality of network slices may be requested for availability (e.g., simultaneously), enabling a registration of the terminal device 702 if at least one network slice is available as exemplified at reference sign 904 in FIG. 9.

The step 602 and/or 504 may be a read-only operation from the NSACF 300 viewpoint. Alternatively or in addition, if one or multiple messages are exchanged between NSSF 200 and NSACF 300 for a plurality of network slices and/or for a plurality of S-NSSAI may depend on application programming (API) design.

At reference sign 606 and/or 506, NSACF 300 sends an indication of a network slice availability to NSSF 200. The indication may comprise one and/or multiple messages sent for a plurality of network slices and/or for a plurality of S-NSSAIs. The number of the indication of the network slice availability messages may be the same as and/or different from the number of network slice availability request messages.

NSSF 200 sends at reference sign 508 a CN response indicative of rejection or admission to at least one network slice regarding terminal device 702, which is received at reference sign 406 by AMF 100.

In case it is determined that the predetermined threshold number of registered terminal devices has been reached and/or exceeded for at least one or a plurality of (e.g., relevant and/or suitable) network slices, NSSF 200 sends in step 508 a CN response message indicative of rejection of the terminal device 702 (also denoted as “NSSelection_Get response” and or “threshold reached response”) to the at least one or each of the plurality of (e.g., relevant and/or suitable) network slices, as shown in FIG. 8.

Alternatively or in addition, NSSF 200 may only send 508 the CN response message indicative of rejection of the terminal device 702 to AMF 100 if the predetermined threshold number of registered terminal devices has been reached and/or exceeded for each of a plurality of (e.g., relevant and/or suitable) network slices. Further alternatively or in addition, NSSF 200 may send a CN response message indicative of admission to at least one network slice, if at least one out of a plurality of network slices is available, according to the exemplary details provided below in the context of FIG. 9.

Contrary to conventional procedures, the CN response message at reference sign 508 and/or 406 may comprise an indication per network slice and/or per NSSAI (e.g., per S-NSSAI), e.g., for which the CN registration request had been sent at reference sign 404 and/or 502. The indication may comprise that the predetermined threshold number of registered terminal devices per network slice (e.g., per NSSAI and/or per S-NSSAI) is already reached. The indication may be subject to API design.

As depicted in FIG. 8, if in the step 406, AMF 100 receives a CN response message indicative of rejection of the terminal device for at least one or a plurality of (e.g., relevant and/or suitable) network slices, in substep step 408-1 of the step 408, AMF 100 sends a registration rejection message (also denoted as “error”) to terminal device 702. The registration rejection message may comprise at least one NSSAI, at least one S-NSSAI and/or an indication that the predetermined threshold number of registered terminal devices has been reached.

Alternatively or in addition, upon reception of the registration rejection message at the terminal device 702, a back-off timer may be started or restarted. The back-off timer may be associated to any one of the network slices (e.g., previously) requested. Alternatively or in addition, the back-off timer may relate to any set of network slices, which may or may not comprise the at least one network slice (e.g., previously) requested.

Alternatively or in addition, AMF 100 may stop any network slice selection procedure and/or CN (e.g., 5GC) registration procedure regarding terminal device 702 upon reception of the registration rejection message in the step 408-1.

FIG. 9 shows an example implementation in case the indication of the network slice availability comprises at least one available network slice to which the terminal device 702 may be admitted. The steps 402, 802, 404 and/or 502 as well as 504 and/or 602 agree with those described in the context of FIG. 8.

In FIG. 9, at reference sign 604, the comparison of the identifier of the terminal device 702 with a list of identifiers of registered terminal devices for at least one network slice (e.g., at least one NSSAI and/or at least one S-NSSAI) indicates that the identifier of the terminal device 702 was already included in the list of identifiers of registered terminal devices. Alternatively or in addition, the counter of registered terminal devices indicates that the predetermined threshold number of registered terminal devices has not yet been reached and that the terminal device 702 may be added to the list of identifiers of registered terminal devices.

At reference sign 606 and/or 506, if the predetermined threshold number has not been reached and/or the identifier of the terminal device 702 was already included in the list of identifiers of registered terminals, NSACF 300 returns a successful response (also denoted as “NumberOfUEsPerSliceAvailabilityCheckAndUpdate response”) and/or an indication of the network slice availability comprising at least one available network slice (e.g., at least one NSSAI and/or S-NSSAI).

If the identifier of the terminal device 702 was not already included in the list of identifiers of registered terminal devices, NSACF 300 may add the identifier of the terminal device 702 to the list of identifiers when sending the indication of the network slice availability at reference sing 606 and/or 506.

Optionally, when adding the identifier of the terminal device 702, a timer may be started. Upon expiry of the timer after a predefined time duration, it may be decided to erase and/or remove the identifier of the terminal device 702 from the list of identifiers, if no indication of a successful authentication, successful registration and/or successful SM policy control was received from any AMF 100 in the step 408-3.

Subsequently, at reference sign 508 and/or 406, NSSF 200 sends a CN response message (also denoted as “NSSelection_Get response”) indicative of admission to the at least one available network slice (e.g., the at least one NSSAI and/or S-NSSAI). The CN response message may comprise at least one AMF (e.g., AMF 100) set and/or a network repository function (NRF) address. Alternatively or in addition, NSSF 200 may include an indication and/or a confirmation that the (e.g., early) admission control has been performed. AMF 100 may later skip the conventional (e.g., early) admission control.

At reference sign 904, AMF 100 (which may be the same AMF 100 that performed steps 402 and 404, or it may be a different AMF 100 associated with the at least one network slice comprised in the indication of the network slice availability) proceeds with authentication, registration and/or SM policy control regarding the terminal device 702.

At reference sign 408-2, AMF 100 sends a registration acceptance message (also denoted as “UE registration accept”) to terminal device 702.

Since AMF 100 may be aware that (e.g., early) admission control was performed (e.g., at reference sign 606 and/or 506), AMF 100 may simply update and/or add the terminal device 702 (e.g., UE) to the list of registered terminal device in the network slice (e.g., the NSSAI and/or S-NSSAI) for which it performed the at least one step at reference sign 904. Alternatively or in addition, the update may comprise a confirmation and/or an acknowledgement to NSACF 300 before expiry of the timer and result in the already added identifier of the terminal device 702 not being erased and/or removed from the list of identifiers.

The step 408-3 may be performed (e.g., approximately) simultaneously (also denoted as “in parallel”) to sending the registration acceptance message (also denoted as “response”) to the terminal device 702. Alternatively or in addition, no (e.g., early) admission control is performed before the response to terminal device 702 is sent.

Alternatively or in addition, the step 408-3 may comprise that NSACF 300 (and/or NSSF 200) check again whether the predetermined threshold number (also denoted as “quota”) has been reached (e.g., since another terminal device 702 might have registered in the network slice in the time between the step 604 and/or 606 and the step 408-3).

Alternatively or in addition, the comparison of the identifier of the terminal device 702 being part of the list of identifiers registered terminal devices need not be repeated at reference sign 408-3, since the comparison was already performed at step 604 (e.g., NSACF 300 previously determined that the terminal device 702 was not registered in the network slice).

Any network node(s) and/or UE(s) embodying the terminal device 702 may be compliant with a 3GGP standard, e.g., according to the document TS 29.531, version 17.0.0 and/or TS 29.536, version 0.1.0.

The technique of (e.g., early) rejection and/or (e.g., early) admission control may be applied to NFs of a CN of a telecommunication system, in particular to at least one AMF (e.g., AMF 100), NSSF (e.g., NSSF 200), NSACF (e.g., NSACF 300) and/or to a network slice function comprising both NSSF and NSACF.

By the (e.g., early) rejection an energy improvement at the network level may be achieved.

Each of the terminal devices 702 may be a radio device or a base station. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

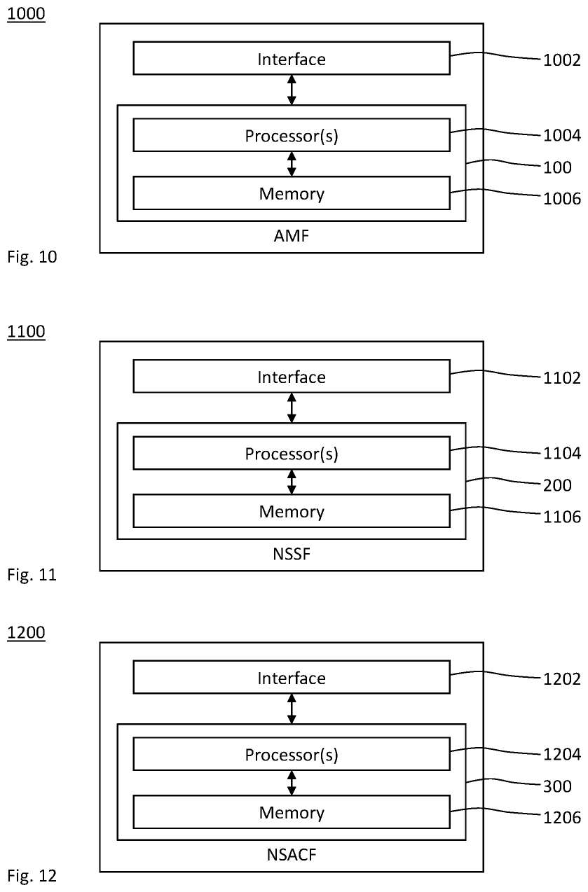

FIG. 10 shows a schematic block diagram for an embodiment of the AMF 100. The AMF 100 comprises processing circuitry, e.g., one or more processors 1004 for performing the method 400 and memory 1006 coupled to the processors 1004. For example, the memory 1006 may be encoded with instructions that implement at least one of the units 102, 104, 106 and 108.

The one or more processors 1004 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the AMF 100, such as the memory 1006, access and mobility management functionality. For example, the one or more processors 1004 may execute instructions stored in the memory 1006. Such functionality may include providing various features and steps discussed herein, including any of the benefits disclosed herein. The expression “the AMF being operative to perform an action” may denote the AMF 100 being configured to perform the action.

As schematically illustrated in FIG. 10, the AMF 100 may be embodied by a device 1000, e.g., functioning as at least one AMF. The device 1000 comprises an interface 1002 coupled to the AMF 100 for (e.g., radio and/or wired) telecommunication with one or more terminal devices (e.g., base stations and/or UEs), the NSSF (e.g., NSSF 200) and/or the NSACF (e.g., NSACF 300).

FIG. 11 shows a schematic block diagram for an embodiment of the NSSF 200. The NSSF 200 comprises processing circuitry, e.g., one or more processors 1104 for performing the method 500 and memory 1106 coupled to the processors 1104. For example, the memory 1106 may be encoded with instructions that implement at least one of the units 202, 204, 206 and 208.

The one or more processors 1104 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the NSSF 200, such as the memory 1106, network slice selection functionality. For example, the one or more processors 1104 may execute instructions stored in the memory 1106. Such functionality may include providing various features and steps discussed herein, including any of the benefits disclosed herein. The expression “the NSSF being operative to perform an action” may denote the NSSF 200 being configured to perform the action.

As schematically illustrated in FIG. 11, the NSSF 200 may be embodied by a device 1100, e.g., functioning as an NSSF. The device 1100 comprises an interface 1102 coupled to the NSSF 200 for (e.g., radio and/or wired) telecommunication with one or more AMFs (e.g., AMF 100) and/or the NSACF (e.g., NSACF 300).

FIG. 12 shows a schematic block diagram for an embodiment of the NSACF 300. The NSACF 300 comprises processing circuitry, e.g., one or more processors 1204 for performing the method 600 and memory 1206 coupled to the processors 1204. For example, the memory 1206 may be encoded with instructions that implement at least one of the units 302, 304 and 306.

The one or more processors 1204 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the NSACF 300, such as the memory 1206, network slice admission control functionality. For example, the one or more processors 1204 may execute instructions stored in the memory 1206. Such functionality may include providing various features and steps discussed herein, including any of the benefits disclosed herein. The expression “the NSACF being operative to perform an action” may denote the NSACF 300 being configured to perform the action.

As schematically illustrated in FIG. 12, the NSACF 300 may be embodied by a device 1200, e.g., functioning as an NSACF. The device 1200 comprises an interface 1202 coupled to the NSACF 300 for (e.g., radio and/or wired) communication with one or more AMFs (e.g., AMF 100) and/or the NSSF (e.g., NSSF 200).

A telecommunication system (e.g., the telecommunication system 800) includes a host computer comprising processing circuitry configured to provide user data. The host computer may further comprise a communication interface configured to forward user data to a (e.g., cellular or ad hoc radio) network for transmission to a UE. The UE comprises a (e.g., radio) interface and processing circuitry. The telecommunication system further comprises at least one AMF (e.g., AMF 100) of a CN (e.g., CN 804). The at least one AMF (e.g., AMF 100) is configured to execute any one of the steps of the first method 400.

The telecommunication system (e.g., the telecommunication system 800) optionally further comprises an NSSF (e.g., NSSF 200) of the CN (e.g., CN 804). The NSSF (e.g., NSSF 200) may be configured to execute any one of the steps of the second method 500. Alternatively or in addition, the telecommunication system (e.g., the telecommunication system 800) still further optionally comprises an NSACF (e.g., NSACF 300) of the CN (e.g., CN 804). The NSACF (e.g., NSACF 300) may be configured to execute any one of the steps of the third method 600.

The telecommunication system (e.g., the telecommunication system 800) may further include the UE (e.g., terminal device 702). Alternatively or in addition, the (e.g., radio) network may further comprise a base station or a radio device (e.g., as the terminal device 702) functioning as a gateway configured to communicate with the UE. Still further alternatively or in addition, the processing circuitry of the host computer may be configured to execute a host application, thereby providing the user data; and the processing circuitry of the UE may be configured to execute a client application associated with the host application.

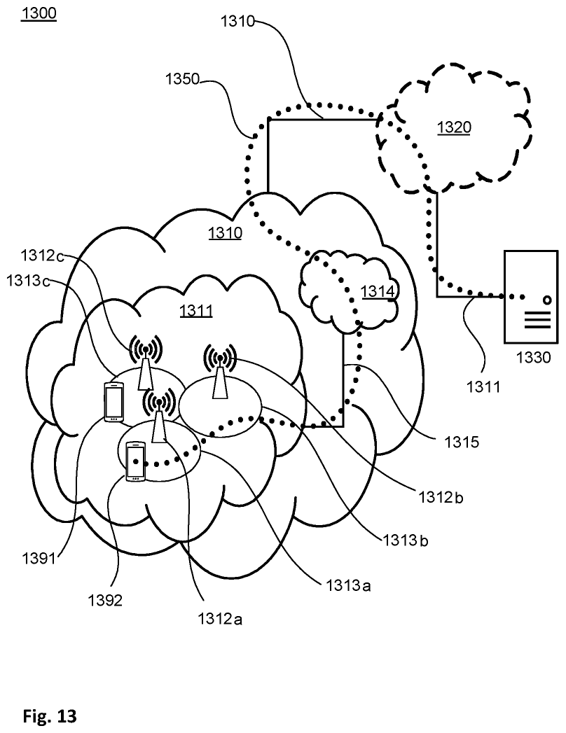

With reference to FIG. 13, in accordance with an embodiment, a communication system 1300 includes a telecommunication network 1310, such as a 3GPP-type cellular network, which comprises an access network 1311, such as a radio access network, and a core network 1314. The access network 1311 comprises a plurality of base stations 1312a, 1312b, 1312c, such as NBs, eNBs, gNBs or other types of wireless access points, each defining a corresponding coverage area 1313a, 1313b, 1313c. Each base station 1312a, 1312b, 1312c is connectable to the core network 1314 over a wired or wireless connection 1315. A first user equipment (UE) 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Any of the base stations 1312 and the UEs 1391, 1392 may embody the terminal device 702.

The telecommunication network 1310 is itself connected to a host computer 1330, which may be embodied in the hardware and/or software of a standalone server, a cloud-implemented server, a distributed server or as processing resources in a server farm. The host computer 1330 may be under the ownership or control of a service provider, or may be operated by the service provider or on behalf of the service provider. The connections 1321, 1322 between the telecommunication network 1310 and the host computer 1330 may extend directly from the core network 1314 to the host computer 1330 or may go via an optional intermediate network 1320. The intermediate network 1320 may be one of, or a combination of more than one of, a public, private or hosted network; the intermediate network 1320, if any, may be a backbone network or the Internet; in particular, the intermediate network 1320 may comprise two or more sub-networks (not shown).

The communication system 1300 of FIG. 13 as a whole enables connectivity between one of the connected UEs 1391, 1392 and the host computer 1330. The connectivity may be described as an over-the-top (OTT) connection 1350. The host computer 1330 and the connected UEs 1391, 1392 are configured to communicate data and/or signaling via the OTT connection 1350, using the access network 1311, the core network 1314, any intermediate network 1320 and possible further infrastructure (not shown) as intermediaries. The OTT connection 1350 may be transparent in the sense that the participating communication devices through which the OTT connection 1350 passes are unaware of routing of uplink and downlink communications. For example, a base station 1312 need not be informed about the past routing of an incoming downlink communication with data originating from a host computer 1330 to be forwarded (e.g., handed over) to a connected UE 1391. Similarly, the base station 1312 need not be aware of the future routing of an outgoing uplink communication originating from the UE 1391 towards the host computer 1330.

By virtue of the methods 400, 500 and 600 being performed by at least one AMF (e.g., AMF 100), an NSSF (e.g., NSSF 200) and an NSACF (e.g., NSACF 300) of the CN 1314 (as an example of the CN 804), respectively, the performance or range of the OTT connection 1350 can be improved, e.g., in terms of increased throughput and/or reduced latency.

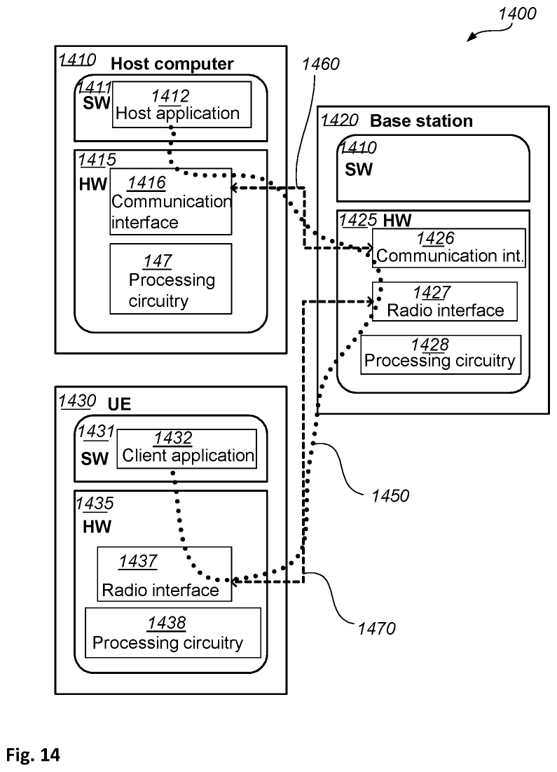

Example implementations, in accordance with an embodiment of the UE, base station and host computer discussed in the preceding paragraphs, will now be described with reference to FIG. 14. In a telecommunication system 1400, a host computer 1410 comprises hardware 1415 including a communication interface 1416 configured to set up and maintain a wired or wireless connection with an interface of a different communication device of the telecommunication system 1400. The host computer 1410 further comprises processing circuitry 1418, which may have storage and/or processing capabilities. In particular, the processing circuitry 1418 may comprise one or more programmable processors, application-specific integrated circuits, field programmable gate arrays or combinations of these (not shown) adapted to execute instructions. The host computer 1410 further comprises software 1411, which is stored in or accessible by the host computer 1410 and executable by the processing circuitry 1418. The software 1411 includes a host application 1412. The host application 1412 may be operable to provide a service to a remote user, such as a UE 1430 connecting via an OTT connection 1450 terminating at the UE 1430 and the host computer 1410. In providing the service to the remote user, the host application 1412 may provide user data, which is transmitted using the OTT connection 1450. The user data may depend on the location of the UE 1430. The user data may comprise auxiliary information or precision advertisements (also: ads) delivered to the UE 1430. The location may be reported by the UE 1430 to the host computer, e.g., using the OTT connection 1450, and/or by the base station 1420, e.g., using a connection 1460.

The telecommunication system 1400 further includes a base station 1420 (e.g., provided in a telecommunication system 800 and) comprising hardware 1425 enabling it to communicate with the host computer 1410 and with the UE 1430. The hardware 1425 may include a communication interface 1426 for setting up and maintaining a wired or wireless connection with an interface of a different communication device of the telecommunication system 1400, as well as a radio interface 1427 for setting up and maintaining at least a wireless connection 1470 with a UE 1430 located in a coverage area (not shown in FIG. 14) served by the base station 1420. The communication interface 1426 may be configured to facilitate a connection 1460 to the host computer 1410. The connection 1460 may be direct, or it may pass through a core network (not shown in FIG. 14) of the telecommunication system 1400 and/or through one or more intermediate networks outside the telecommunication system 1400. In the embodiment shown, the hardware 1425 of the base station 1420 further includes processing circuitry 1428, which may comprise one or more programmable processors, application-specific integrated circuits, field programmable gate arrays or combinations of these (not shown) adapted to execute instructions. The base station 1420 further has software 1421 stored internally or accessible via an external connection.

The telecommunication system 1400 further includes the UE 1430 already referred to. Its hardware 1435 may include a radio interface 1437 configured to set up and maintain a wireless connection 1470 with a base station serving a coverage area in which the UE 1430 is currently located. The hardware 1435 of the UE 1430 further includes processing circuitry 1438, which may comprise one or more programmable processors, application-specific integrated circuits, field programmable gate arrays or combinations of these (not shown) adapted to execute instructions. The UE 1430 further comprises software 1431, which is stored in or accessible by the UE 1430 and executable by the processing circuitry 1438. The software 1431 includes a client application 1432. The client application 1432 may be operable to provide a service to a human or non-human user via the UE 1430, with the support of the host computer 1410. In the host computer 1410, an executing host application 1412 may communicate with the executing client application 1432 via the OTT connection 1450 terminating at the UE 1430 and the host computer 1410. In providing the service to the user, the client application 1432 may receive request data from the host application 1412 and provide user data in response to the request data. The OTT connection 1450 may transfer both the request data and the user data. The client application 1432 may interact with the user to generate the user data that it provides.

It is noted that the host computer 1410, base station 1420 and UE 1430 illustrated in FIG. 14 may be identical to the host computer 1330, one of the base stations 1312a, 1312b, 1312c and one of the UEs 1391, 1392 of FIG. 13, respectively. This is to say, the inner workings of these entities may be as shown in FIG. 14, and, independently, the surrounding network topology may be that of FIG. 13.

In FIG. 14, the OTT connection 1450 has been drawn abstractly to illustrate the communication between the host computer 1410 and the UE 1430 via the base station 1420, without explicit reference to any intermediary devices and the precise routing of messages via these devices. Network infrastructure may determine the routing, which it may be configured to hide from the UE 1430 or from the service provider operating the host computer 1410, or both. While the OTT connection 1450 is active, the network infrastructure may further take decisions by which it dynamically changes the routing (e.g., on the basis of load balancing consideration or reconfiguration of the network).

The wireless connection 1470 between the UE 1430 and the base station 1420 is in accordance with the teachings of the embodiments described throughout this disclosure. One or more of the various embodiments improve the performance of OTT services provided to the UE 1430 using the OTT connection 1450, in which the wireless connection 1470 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1450 between the host computer 1410 and UE 1430, in response to variations in the measurement results. The measurement procedure and/or the network functionality for reconfiguring the OTT connection 1450 may be implemented in the software 1411 of the host computer 1410 or in the software 1431 of the UE 1430, or both. In embodiments, sensors (not shown) may be deployed in or in association with communication devices through which the OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of the OTT connection 1450 may include message format, retransmission settings, preferred routing etc.; the reconfiguring need not affect the base station 1420, and it may be unknown or imperceptible to the base station 1420. Such procedures and functionalities may be known and practiced in the art. In certain embodiments, measurements may involve proprietary UE signaling facilitating the host computer's 1410 measurements of throughput, propagation times, latency and the like. The measurements may be implemented in that the software 1411, 1431 causes messages to be transmitted, in particular empty or “dummy” messages, using the OTT connection 1450 while it monitors propagation times, errors etc.

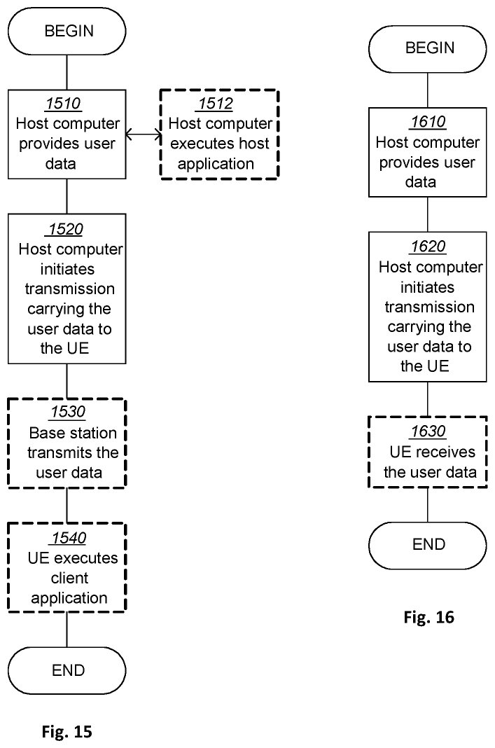

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this paragraph. In a first step 1510 of the method, the host computer provides user data. In an optional substep 1511 of the first step 1510, the host computer provides the user data by executing a host application. In a second step 1520, the host computer initiates a transmission carrying the user data to the UE. In an optional third step 1530, the base station transmits to the UE the user data which was carried in the transmission that the host computer initiated, in accordance with the teachings of the embodiments described throughout this disclosure. In an optional fourth step 1540, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this paragraph. In a first step 1610 of the method, the host computer provides user data. In an optional substep (not shown) the host computer provides the user data by executing a host application. In a second step 1620, the host computer initiates a transmission carrying the user data to the UE. The transmission may pass via the base station, in accordance with the teachings of the embodiments described throughout this disclosure. In an optional third step 1630, the UE receives the user data carried in the transmission.

As has become apparent from above description, at least some embodiments of the technique allow for performing network slice rejection and/or network slice admission control (e.g., in terms of a maximum number of registered terminal devices, e.g., UEs, in a network slice) at the first stages of the CN (e.g., 5GC) registration, that is, when the network slice is to be selected.

Alternatively or in addition, embodiments of the technique can save or avoid useless procedures of authentication, registration and/or SM policy control attempts when the network slice quota (e.g., the maximum number of registered terminal devices) has been reached or exceeded.

Further alternatively or in addition, embodiments of the technique allows for (e.g., potential) optimizations in network slice (e.g., selection and/or access control) functionality based on the identity of the terminal device. E.g., a given terminal device (e.g., UE) received at the NSSF, before checking network slice quota, can be subject to no admission control. Hence the network slice function (e.g., comprising NSSF and/or NSACF), even if the network slice quota has been reached, may grant access for the related terminal device (e.g., UE).

Still further alternatively or in addition, embodiments of the technique can improve energy and/or power saving at the network level.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

### ABBREVIATION EXPLANATION

5GC Fifth Generation Core
AC Admission Control
AMF Access and Mobility Function
ARF Access Rule File
AUSF Authentication Server Function
EAC Early Admission Control
NSACF Network Slice Admission Control Function
NSSF Network Slice Selection Function
Network Slice Selection Assistance Information NSSAI
Policy Control Function PCF
SM Session Management
S-NSSAI Single NSSAI
TAI Tracking Area Identity
UDM Unified Data Management
UDR Unified Data Repository
UE User Equipment

1. A method of handling rejection and admission of a terminal device to a core network, CN, of a telecommunication system, the method comprising:
receiving a terminal device registration request indicative of the terminal device requesting access to the telecommunication system;
sending, to a network slice selection function, NSSF, of the CN, a CN registration request message indicative of the terminal device registration request, wherein the CN registration request message comprises an identifier of the terminal device, and wherein the CN registration request message is further indicative of at least one network slice of the telecommunication system;
receiving, from the NSSF, a CN response message indicative of rejection or admission to at least one network slice regarding the terminal device based on the identifier of the terminal device; and
selectively initiating registration of the terminal device, wherein the selectivity depends on whether the CN response message indicates rejection or admission to at least one network slice regarding the terminal device.

2. The method of claim 1, wherein the terminal device registration request comprises an indication of at least one of:
at least one network slice; and
a slice and/or service type, SST, of at least one network slice.

3. The method of claim 2, wherein the terminal device registration request further comprises an indication of a slice differentiator, SD, of the at least one network slice.

4. The method of claim 1, wherein the terminal device registration request comprises network slice selection assistance information, NSSAI.

5. The method of claim 1, wherein the identifier of the terminal device is indicative of a priority of the terminal device.

6. The method of claim 5, wherein the identifier of the terminal device comprises at least one of a subscription permanent identifier, SUPI, and an international mobile subscriber identity, IMSI.

7. The method of claim 1, wherein the CN registration request message comprises a tracking area identity, TAI, associated with the terminal device and/or with the at least one network slice indicated in the terminal device registration request.

8. The method of claim 1, wherein the CN registration request message comprises an indication that early rejection is supported, wherein early rejection comprises rejection of the terminal device before initiating authentication and/or registration of the terminal device.

9. The method of claim 1, wherein the step of selectively initiating registration of the terminal device comprises at least one of:
sending a registration rejection message to the terminal device if the received CN response message is indicative of rejection of the terminal device; and
sending a registration acceptance message to the terminal device if the received CN response message is indicative of admission of the terminal device to at least one network slice, optionally and if at least one of authentication, registration and session management, SM, policy control of the terminal device is successfully performed by an access and mobility function, AMF, of the CN.

10. The method of claim 9, wherein the registration acceptance message comprises an indication of the at least one network slice to which the terminal device is admitted.

11. The method of claim 9, wherein, if the received CN response message is indicative of admission of the terminal device, the step of selectively initiating registration of the terminal device further comprises:
sending an indication of the initiation of the registration of the terminal device to a network slice admission control function, NSACF.

12. The method of claim 1, wherein the method is performed by at least one access and mobility function, AMF, of the CN.

13. A method of determining rejection and admission of a terminal device to a core network, CN, of a telecommunication system, the method comprising or initiating the steps of:
receiving, at a network slice selection function, NSSF, of the CN, a CN registration request message indicative of a terminal device registration request to at least one network slice of the telecommunication system, wherein the CN registration request message comprises an identifier of the terminal device; and
sending, from the NSSF, a CN response message indicative of rejection or admission to at least one network slice regarding the terminal device based on the identifier of the terminal device.

14. The method of claim 13, further comprising the steps of:
sending, from the NSSF, a network slice availability request to a network slice admission control function, NSACF, regarding the terminal device, wherein the network slice availability request comprises the identifier of the terminal device and at least one identifier of at least one network slice; and
receiving, at the NSSF from the NSACF, an indication of a network slice availability responsive to the network slice availability request and based on the identifier of the terminal device and at least one identifier of at least one network slice.

15. (canceled)

16. A method of controlling rejection and admission of a terminal device to a core network, CN, of a telecommunication system, the method comprising or initiating the steps of:
receiving, at a network slice admission control function, NSACF, of the CN from a network slice selection function, NSSF, of the CN, a network slice availability request regarding a terminal device, wherein the network slice availability request comprises an identifier of the terminal device and at least one identifier of at least one network slice; and
sending, from the NSACF to the NSSF, an indication of a network slice availability responsive to the network slice availability request and based on the identifier of the terminal device and at least one identifier of at least one network slice.

17. The method of claim 16, wherein the identifier of the terminal device comprises at least one of a subscription permanent identifier, SUPI, and an international mobile subscriber identity, IMSI.

18. The method of claim 17, wherein the NSACF comprises a counter of registered terminal devices for each of the at least one network slice.

19. The method of claim 18, wherein the counter of registered terminal devices further comprises a list of identifiers of at least one or each of the registered terminal devices for each of the at least one network slice.

20. The method of claim 19, wherein the identifier of the terminal device, for which network slice availability is requested, is compared to the list of identifiers of at least one or each of the registered terminal devices for the at least one network slice, and wherein at least one of:
the counter of registered terminal devices is incremented and/or the identifier of the terminal device, for which network slice availability is requested, is added to the list of identifiers if the comparison indicates that the identifier of the terminal device, for which network slice availability is requested, was not comprised in the list of identifiers; and
the counter of registered terminal devices is not incremented and/or the list of identifiers is maintained if the comparison indicated that the identifier of the terminal device, for which network slice availability is requested, was comprised in the list of identifiers.

21. The method of claim 17, wherein the NSACF further comprises a predetermined threshold number of registered terminal devices for the at least one or each network slice of the telecommunication system, and wherein the indication of the network slice availability comprises an indication if, based on the counter of registered terminal devices, the predetermined threshold number of registered terminal devices of the at least one network slice is reached and/or exceeded.

22-44. (canceled)
